(19) United States
(12) Patent Application Publication
(10) Pub. No.: US 2010/0071961 A1
(43) Pub. Date: Mar. 25, 2010

(54) BIT LEG OUTER SURFACE PROCESSING USING FRICTION STIR WELDING (FSW)

(75) Inventors: Russell J. Steel, Salem, UT (US); Scott M. Packer, Alpine, UT (US); Cary A. Roth, Spring, TX (US); Madapusi K. Keshavan, The Woodlands, TX (US)

Correspondence Address: OSHA, LIANG LLP / SMITH, TWO HOUSTON CENTER, 909 FANNIN STREET, SUITE 3500, HOUSTON, TX, 77010, US

(73) Assignee: SMITH INTERNATIONAL, INC., Houston, TX (US)

(21) Appl. No.: 12/629,366

(22) Filed: Dec. 2, 2009

Related U.S. Application Data
(63) Continuation-in-part of application No. 11/136,609, filed on May 23, 2005.
Application No. 11/136,609 is a continuation of application No. 11/090,317, filed on Mar. 24, 2005, now abandoned.
Application No. 11/090,317 is a continuation of application No. 11/090,909, filed on Mar. 24, 2005.
(60) Provisional application No. 60/652,808, filed on Feb. 14, 2005.
(60) Provisional application No. 60/637,223, filed on Dec. 17, 2004.
(60) Provisional application No. 60/573,707, filed on May 21, 2004.

(51) Int. Cl. E21B 10/08; B23K 20/12; E21B 10/50; B23P 15/28; B23P 11/00

(52) U.S. Cl. 175/375; 228/112.1; 51/307; 51/309; 175/374; 76/108.2; 29/428

(57) ABSTRACT

A roller cone drill bit includes a bit body and at least one leg extending downward from the bit body. Each leg includes an outer surface, a ball hole plug located in the outer surface, a shoulder, a shirttail, and a roller cone rotatably mounted to the leg. The outer surface of each leg is surface processed by friction stirring.

### CROSS-REFERENCE TO RELATED APPLICATIONS

This application claims the benefit pursuant to 35 U.S.C. §120 as a continuation-in-part application of U.S. patent application Ser. No. 11/136,609, filed on May 23, 2005, which claims priority to all of the subject matter included in provisional applications with Ser. No. 60/573,707, filed May 21, 2004, Ser. No. 60/637,223, filed Dec. 17, 2004 and Ser. No. 60/652,808, filed Feb. 14, 2005, and non-provisional applications with Ser. No. 11/090,909, filed Mar. 24, 2005 and Ser. No. 11/090,317, filed Mar. 24, 2005. The above referenced applications are hereby incorporated by reference in their entirety.

### BACKGROUND OF INVENTION

1. Field of the Invention

Embodiments disclosed herein relate generally to drill bits used to bore holes through earth formations. In particular, embodiments disclosed herein relate generally to roller cone drill bits that are treated by friction stirring.

2. Background Art

Historically, there have been two main types of drill bits used in drilling earth formations, drag bits and roller cone bits. The term “drag bits” refers to those rotary drill bits with no moving elements. Drag bits include those having cutters attached to the bit body, which predominantly cut the formation by a shearing action. Roller cone bits include one or more roller cones rotatably mounted to the bit body. These roller cones have a plurality of cutting elements attached thereto that crush, gouge, and scrape rock at the bottom of a hole being drilled.

Roller cone drill bits typically include a main body with a threaded pin formed on the upper end of the main body for connecting to a drill string, and one or more legs extending from the lower end of the main body. Referring to FIG. 1, a conventional roller cone drill bit, generally designated as 10, consists of bit body 11 forming an upper pin end 12 and a cutter end of roller cones 13 that are supported by legs 14 extending from body 11. Each leg 14 includes a journal 15 extending downwardly and radially inward towards a center line of the bit body 11, with cones 13 mounted thereon. Each of the legs 14 terminate in a shirttail portion 16. The threaded pin end 12 is adapted for assembly onto a drill string (not shown) for drilling oil wells or the like.

Conventional roller cone bits are typically constructed from at least three segments. The segments are often forged pieces having an upper body portion and a lower leg portion. The lower leg portion is machined to form the shirttail section and the journal section. Additionally, lubricant reservoir holes, jet nozzle holes, and ball races are machined into the forgings. Roller cones are mounted onto the formed journals, and the leg segments are positioned together longitudinally with journals and cones directed radially inward to each other. The segments may then be welded together using conventional techniques to form the bit body. Upon being welded together, the internal geometry of each leg section forms a center fluid plenum. The center fluid plenum directs drilling fluid from the drill string, out nozzles to cool and clean the bit and wellbore, etc.

As drilling fluids are circulated through the wellbore, the debris created from crushing the formation is evacuated away from the wellbore bottom, and occasionally hits and damages the bit. The bit may also be subject to corrosion, damage from contact with the wellbore wall, cyclic fatigue due to excessive loading, and others. Accordingly methods for improving the wear resistance of drill bits are continually sought after.

A common method currently used in the industry for improving the wear resistance of a bit is to apply a hardfacing material, such as by arc or gas welding, to the outer surface of the legs of the bit as well as to the cutting structure. In prior art, hardfacing has been applied to different portions of the bit legs, such as on the shirttail of each bit leg, along the leading or trailing sides of each bit leg, on any portion between the shirttail and sides of a leg except for the area over the ball hole plug, or combinations of the aforementioned portions. For example, U.S. Patent App. No. 2007/0163812 describes a hardfacing covering substantially the entire outer surface of a leg (except for the area over the ball hole plug), whereas U.S. Pat. No. 7,182,162 describes applying a layer of hardfacing to the leading side, trailing side, and shirttail surfaces of a leg.

To be effective, the hardfacing must be resistant to loss of material by flaking, chipping, and bond failure with the bit. The hardfacing material typically includes hard, abrasive particles, such as metal carbides, which are bonded to a bit leg by a metal alloy (“binder alloy”). In effect, the hard particles are suspended in a matrix of metal forming a layer on the surface of the leg. The hard particles give the hardfacing material hardness and wear resistance, while the matrix metal provides fracture toughness to the hardfacing. The hard, abrasive particles most commonly used in hardfacing and cutting elements are tungsten carbide. Among the various types of tungsten carbide commonly used for drill bit components are cast tungsten carbide, macro-crystalline tungsten carbide, carburized tungsten carbide, and cemented tungsten carbide (also known as sintered tungsten carbide). Commonly used binder alloys include steel and iron-, cobalt- and nickel-based alloys.

Conventional welding techniques that are used to apply hardfacing include atomic hydrogen welding, oxyacetylene welding, plasma transferred arc (“PTA”), gas tungsten arc, shield metal arc processes, and other gas and arc welding processes. Thermal deposition processes well known in the art may also be used to apply hardfacing. In oxyacetylene welding, for example, the hardfacing material is typically supplied in the form of a tube or hollow rod (“a welding tube”) that is filled with granular material of a selected composition. The tube is usually made of steel (iron) or a similar metal (e.g., nickel or cobalt) that can act as a binder when the rod and its granular contents are heated.

Gas and arc welding processes are characterized by establishing an arc between an electrode (either consumable or non-consumable) and one or more metal base materials. The arc creates intense heat, which melts the metal base material. As the melted material cools and solidifies, a metallurgical bond is created, thereby joining the metals. In plasma arc welding, gas furnished by means of an external gas or an ingredient from a tubular wire is heated to a high temperature and ionized to form electrically conductive plasma. The temperature of the plasma is in excess of 10,000 degrees Kelvin and is highest at the center of the weld, and decreases along the width of the weld. The high temperature plasma is then precisely channeled through an arc to melt and weld the base material. Examples of gas and arc welding processes include: GMAW (gas metal arc welding), GTAW (gas tungsten arc welding), PTA (plasma transferred arc), and FCAW (flux cored arc welding).

However, there is some limitation on the types of materials that may be used with conventional welding methods, such as GMAW, GTAW, PTA, and FCAW. Additionally, such methods result in detrimental heat affected zones (HAZ), cracking tendencies, and although conventional welding methods may provide good wear resistance, toughness is still lacking.

Wear by abrasion and impact mechanisms is a continuing concern in many segments of the drilling industry. Accordingly, there is a continuing need for improvements in the properties of material used for drill bits and other wear surfaces by applying treatment techniques and/or material in order to increase the component's service life.

### SUMMARY OF INVENTION

In one aspect, embodiments disclosed herein relate to a roller cone drill bit including a bit body and at least one leg extending downward from the bit body. Each leg includes an outer surface that is surface processed by friction stirring, a ball hole plug located in the outer surface, a shoulder, a shirttail, and a roller cone rotatably mounted to each leg.

In another aspect, embodiments disclosed herein relate to a method for surface processing a roller cone drill bit, wherein the roller cone drill bit has a bit body and at least one leg extending from the bit body, including friction stirring the outer surface of a leg using a friction stir welding tool.

In yet another aspect, embodiments disclosed herein relate to methods for surface processing a roller cone drill bit, wherein the roller cone drill bit has a bit body and at least one leg extending downward from the bit body. Methods include applying a wear resistant material, a hardface tape, a plate, or a combination thereof, to the outer surface of a roller cone drill bit leg and friction stir mixing the wear resistant material, hardface tape, and/or plate into the roller cone drill bit.

Other aspects and advantages of the invention will be apparent from the following description and the appended claims.

### BRIEF DESCRIPTION OF DRAWINGS

FIG. 1 is a conventional roller cone drill bit.

FIG. 2A illustrates use of a friction stirring tool in accordance with one embodiment.

FIG. 2B illustrates use of a friction stirring tool to friction stir multiple interfaces.

FIG. 3A shows a friction stirred outer surface of a drill bit leg.

FIG. 3B shows a plate friction stirred to the outer surface of a bit leg.

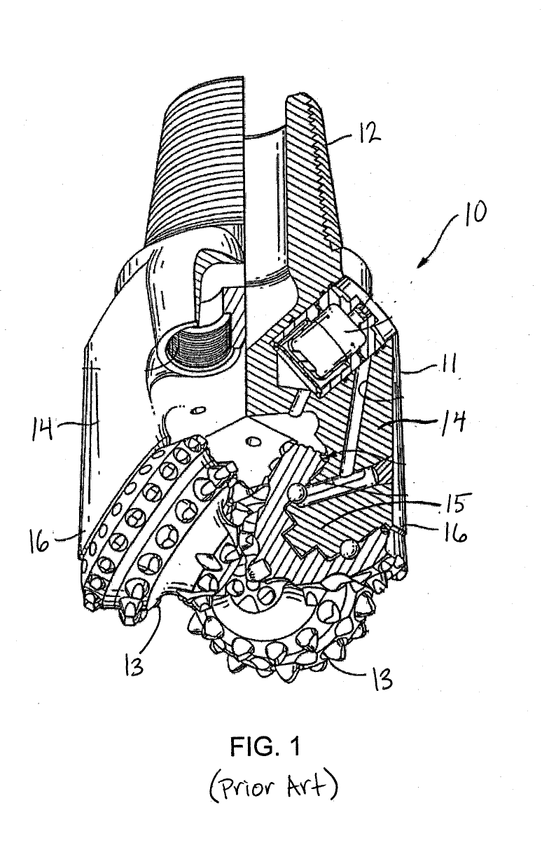

### DETAILED DESCRIPTION

Generally, embodiments disclosed herein relate to surface processing earth-boring cutting tools. In particular, embodiments disclosed herein relate to methods and apparatus for surface processing a roller cone drill bit using friction stirring.

The methods of the present disclosure relate to friction stirring downhole drill bits. Downhole drill bits may include, for example, roller cone drill bits and fixed cutter drill bits, such as PDC matrix bits, impregnated bits, diamond bits, etc. However, one skilled in the art would appreciate that the methods of the present disclosure are not so limited, and friction stirring may instead be used to treat a wear reducing material located on any downhole component. Additionally, friction stirring may be used in combination with other treatment methods to improve wear resistance of the downhole drill bits. Some embodiments of the present disclosure relate to using friction stirring to treat wear resistant material that was previously applied to a downhole drill bit using techniques other than friction stirring.

Friction stirring is a process by which frictional heat plasticizes, mixes and forges metal, metal alloys, and other materials. Friction stirring uses a combination of rotational and directional motion applied to the surface of an object to be treated. A rotating member is conventionally applied to the surface that is to be friction stirred and is moved in a particular direction until a plasticized state of the material is achieved. The rotating member is moved along the surface to treat the material by changing the material microstructure. Friction stirring includes friction stir processing, friction stir mixing, and friction stir welding (FSW). Friction stir processing is a treatment process, which generally involves engaging two or more previously adjoined materials (i.e., previous weld) to strengthen or improve the weld characteristics. Alternatively, friction stir processing may refer to treating a single material of a workpiece. FSW involves engaging two or more adjoining materials to form a weld.

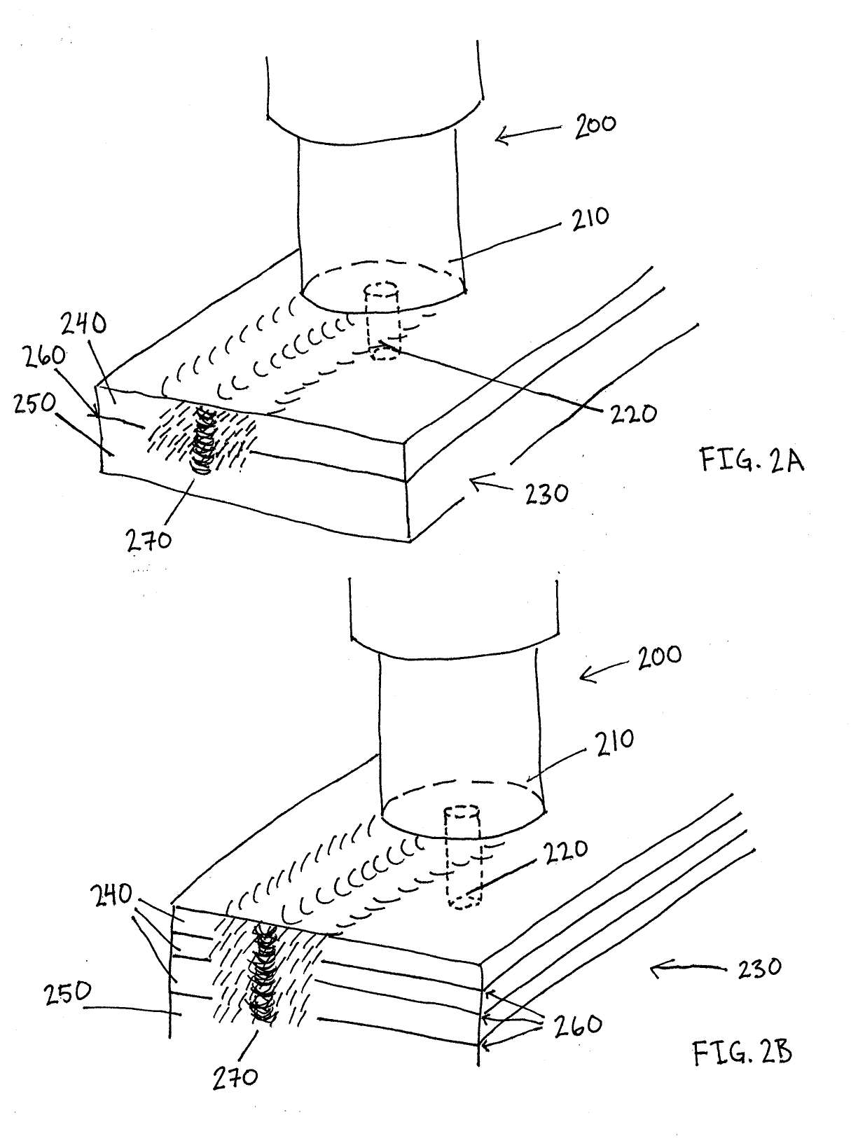

FIG. 2A is a perspective view of a tool being used for friction stirring that is characterized by a generally cylindrical tool 200 having a shoulder 210 and a pin 220 extending downward from the shoulder. The pin 220 is rotated as force is exerted to urge the pin 220 into a workpiece 230. The workpiece 230 often comprises a friction stirring material 240, a base material 250, and an interface (or joint) 260 between the friction stirring material 240 and base material 250. Frictional heating caused by the interaction between the pin 220 and the workpiece 230 causes the workpiece material to soften without reaching a melting point of any of the workpiece materials and results in plasticization of the workpiece material. Once sufficient heat is generated, the pin 220 is plunged into the workpiece 230 through the interface 260. The tool 200 is then moved along the workpiece 230, plasticizing the workpiece material as it flows around the pin 220. The result is a solid state bond 270 between the friction stirring material 240 and the base material 250. Friction stir welding does not require a solder or filler material, but the use of an additional material is not necessarily outside the scope of the present invention.

A solid state bond is an inter-metallic atomic bond formed by mechanical deformation from the friction stirring process. A solid state bond differs from bonds formed by conventional welding techniques (i.e., welds resulting in a fusion bond or solder or braze bond) in that a bond formed by conventional welding techniques is not created by mechanical deformation, but rather, by melting the weld material and solidifying it to form a bond. The high rates of heating and cooling during conventional welding may result in non-uniformity throughout the microstructure of the welded material, which may create different strain rates and increased stress within the welded material. A solid state bond, on the other hand, does not require the workpiece material to melt. Thus, more uniformity of the microstructure, and better mechanical properties of the welded material may be achieved. For example, a solid state bond may have substantially no metallurgical discontinuities, including minimal or no porosity.

Alternatively, as shown in FIG. 2B, multiple layers of friction stirring material 240 (e.g., multiple hardfacing layers) may be applied to the base material 250 of a workpiece, thereby creating multiple interfaces 260, and then friction stirred together using a FSW tool 200.

One skilled in the art would appreciate that when friction stirring, for example, a wear resistant material onto an outer surface of a drill bit, the friction stirring tool is moved along the interface in such a manner that the pin is oriented perpendicular to the interface or joint plane. However, the friction stirring tool may also be moved along the interface in such a manner that the pin presses into the interface at an orientation that is co-planar with the interface/joint between the two materials. Depending on the component being friction stirred and its configuration, one skilled in the art would appreciate that either orientation of the tool may be used.

Large forces are exerted between the pin and the workpiece in order to apply sufficient pressure to the workpiece to cause plasticization of the material. For example, for friction stir welding an aluminum alloy workpiece of ¼-inch thickness, forces of up to 4000 pounds or more may have to be exerted between the pin and the workpiece. Where the workpieces have sufficient structural strength and rigidity, some of the force may be absorbed by the workpieces themselves.

It is also within the scope of the present disclosure that the friction stirring process may be accomplished in one or more passes, depending, for example, on the width of the material to be treated. Thus, for example, for a workpiece area wider than an available friction stir processing tool, multiple passes of stirring may be performed. During such multiple passes, some embodiments may change the direction of rotation of the tool while other embodiments may use the same rotation direction between the multiple passes.

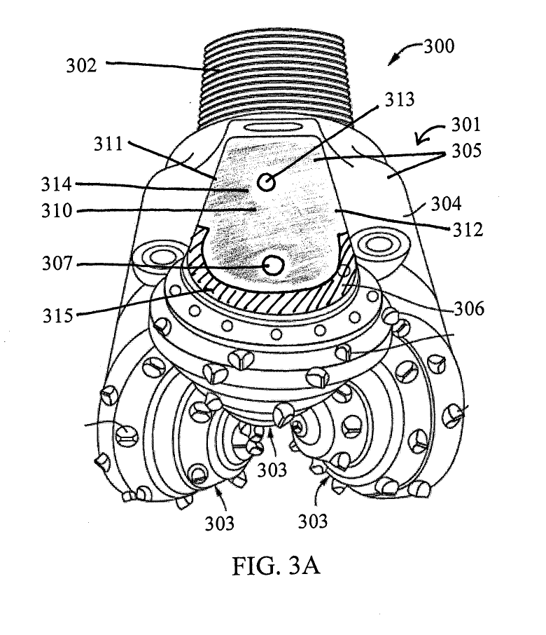

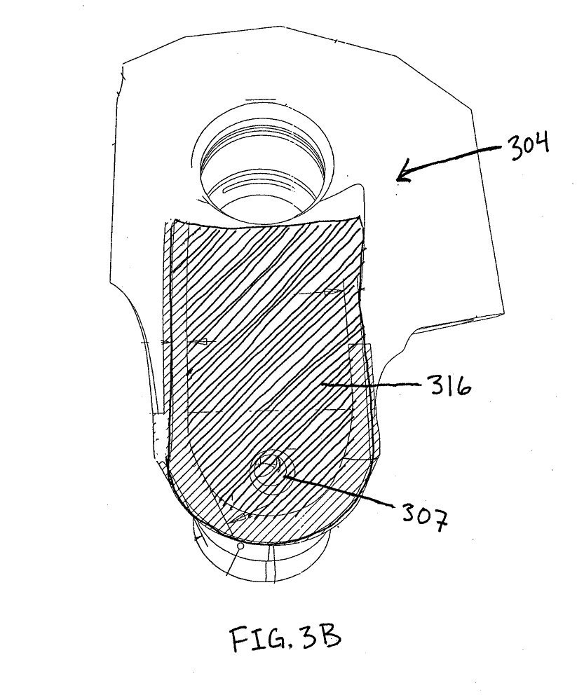

FIGS. 3A and 3B show an example of an earth-boring bit, particularly a roller cone drill bit 300, in accordance with embodiments of the present disclosure. The roller cone bit 300 includes a bit body 301 forming an upper pin end 302 and a cutter end of roller cones 303 that are supported by legs 304 extending downward from the bit body. The threaded upper pin end 302 is adapted for assembly onto a drill string (not shown) for drilling oil wells or the like. Each leg 304 includes a shoulder 305, shirttail 306, a ball hole plug 307, and a journal (not shown) extending downwardly and radially inward towards a center line of the bit body 301, with roller cones 303 mounted thereon. The roller cones 303 are typically sealed to the journal assembly by an elastomer ring or similar device to prevent fluids and debris from the wellbore from entering the journal. Each leg 304 has an outer surface 310, which refers to an exterior surface of the leg that generally spans the region between the shoulder 305 and shirttail portion 306 and between the leading side 311 and trailing side 312 of the leg. The legs 304 of a roller cone drill bit may also have a dimple 313, which is used during the formation of the drill bit when welding the forged legs together.

In one embodiment of the present disclosure, as shown in FIG. 3A, the leg 304 comprises a friction stirred outer surface, represented by the shaded area labeled 314, and shirttail 306 having a hardfaced portion 315. The hardfaced portion 315 has been hardfaced by conventional welding techniques. The leg 304 has been friction stirred using a FSW tool in an area covering the part of the outer surface 310, extending from a distance from the leading side 311 of the leg to a distance from a trailing side 312 of the leg and from a distance from the hardfaced shirttail 306 to the shoulder, excluding the area of the ball hole plug 307 and the dimple 313. The leading and trailing distance (i.e., the distance to the friction stirred area from the leading side and the trailing side, respectively) may be at least ⅛ of an inch, and preferably ½ of an inch. Likewise, the distance to the friction stirred area from the hardfaced shirttail may be at least ⅛ of an inch, and preferably ½ of an inch.

In one embodiment of the present disclosure the leg base material is friction stirred without prior application of a friction stirring material to increase the hardness and other properties. In other embodiments of the present disclosure, the dimple 313 and/or the ball hole plug 307, which are never hardfaced according to conventional welding techniques, may also be friction stirred. Additionally, although FIG. 3A shows hardfacing 315 applied to the leading side 311 of the leg, the shirttail 306, and the trailing side 312 of the leg (depicted as diagonal lines), hardfacing may be applied in a variety of shapes and forms and by any means known in the art, or no hardfacing may be applied.

In another embodiment of the present disclosure, as shown in FIG. 3B, the leg 304 comprises a plate 316 friction stir welded to the outer surface 310 of the leg 304. The plate 316 (shown as diagonal lines) may comprise nickel or stainless steel alloys, high strength steel alloys, or any air hardenable steel, including D2 and A2 steel, or alloy steels such as 4130, 4140, 4145, 4815, 9313, and 8720 steels. The plate 316 may have a thickness of ⅛ of an inch or greater. In such an embodiment, the ball hole plug 307 may be welded (by conventional means or by friction stir welding) to the leg prior to friction stir welding the plate to the leg, or alternatively, the ball hole plug and the plate may be friction stir welded to the leg during a single friction stirring process. However, while the leg may be friction stirred prior to or after assembly of the drill bit, the ball hole plug must be welded before the drill bit is assembled. Thus, if a plate is to be friction stir welded after assembly of the drill bit, the ball hole plug must have been welded to the leg prior to welding the plate to the leg.

In a particular embodiment, if a lower carbon content steel is desired for the leg material, based on other manufacturing consideration, etc., it may be desirable to incorporate therewith a plate having a higher carbon content and thus inherent hardness. For example, the plates may have higher carbon contents, including up to 2 weight percent carbon, which may provide a greater hardness.

Alternatively, an intermediate material may be placed between the leg and the plate, as shown in FIG. 3B, and friction stir welded. For example, in one exemplary embodiment of the present disclosure, a carbide tape may be applied to the surface of a leg and then a strip of steel is placed on top of the carbide tape. The leg, carbide tape, and steel strip are then friction stir welded together to form a leg composite of steel with carbide particles dispersed in the matrix.

Generally, the base material of a bit leg may be made from carburized steels having low weight percentages of carbon, and particularly, carburized steels having at least 0.1 weight percent carbon, but not more than 0.2 weight percent. For example, 4815, 8720, 4718, and 9313 steels may be used as the bit leg material. However, it is also within the scope of the present disclosure that bit leg material may be made of steels with a higher carbon content, such as 4130, 4140, and 4145 steel.

In an embodiment of the present disclosure a friction stirring material is applied to the leg base material prior to friction stirring. Friction stirring material that may be friction stir welded to a drill bit base material may be selected so as to control mechanical properties of the drill bit, including one or more of the following unique properties: improved corrosion resistance, higher toughness or equivalent toughness, higher hardness, fatigue resistance, crack resistance, minimal or no significant heat affected zone, and higher yield strength and wear resistance than the base material used in a drill bit.

Friction stirring material may be material other than and including wear resistant material. For example, friction stirring material may be selected from one or more metal carbides, such as tungsten carbide suspended in a metal binder alloy. Commonly used types of tungsten carbide are cast tungsten carbide, macro-crystalline tungsten carbide, carburized tungsten carbide, and cemented tungsten carbide (also known as sintered tungsten carbide). In such an embodiment, for example, tungsten carbide particles are thermal sprayed to the surface of a leg. The tungsten carbide particles are then friction stirred, thereby incorporating the particles into the leg base material. It is also within the scope of this disclosure to incorporate hard particles of carbides, oxides, nitrides, etc. into the base material by FSW.

Other friction stirring material includes austenitic stainless steel, carbon steels, low alloy carburizing steel, high alloy carbon steel, cobalt and nickel based alloys, and other wear resistant alloys.

Additionally, friction stirring materials may include, for example, metal matrix composites, ferrous alloys such as steel and stainless steel, and non-ferrous materials such as aluminum, aluminum alloys, and titanium, super alloys such as nickel-, iron-, and cobalt-based alloys generally suitable for use at temperatures above 1,000 degrees Fahrenheit, and air hardened steels. These materials may be described as “high melting temperature compounds,” or compounds having a melting temperature greater than steel. Additional elements in the types of materials being friction stirred include, but are not limited to, chromium, molybdenum, manganese, silicon, carbon, boron, tungsten, aluminum, titanium, niobium, tantalum, vanadium, nickel, cobalt, zirconium, phosphorus, and rhenium.

High melting temperature compounds have particular use in the drilling industry.

For example, such materials may be used to hardface the outer surface of a drill bit. Hardfaced material may then be treated using the friction stirring methods disclosed herein, depending on the desired material properties for the particular application, such as hardness, toughness, wear resistance, etc. Additionally, high melting temperature compounds may form the base material of tool components used in the drilling industry. However, lower melting temperature alloys may also be used. Further, the alloy may be provided with tungsten carbide particles dispersed therein.

Friction stirring material may be applied as hard particles, as a tape, or as a plate, for example, to a base material prior to friction stirring. Methods of application include: thermal spraying, plasma spraying, using adhesives to bind the friction stirring material to the base material, entrenching a packed powder into the surface of the base material, sandwiching a first friction stirring material between the base material and a second friction stirring material, etc.

Alternatively, the friction stirring material may have been previously applied to a base material using a variety of conventional techniques, such as GMAW (gas metal arc welding), GTAW (gas tungsten arc welding), PTA (plasma transferred arc), FCAW (flux cored arc welding), etc. Due to the phase transformations (to liquid state, then cooled to a solid state) that occur during such conventional techniques, the microstructure can possess undesirable characteristics, such as precipitation of unwanted phases or structures, grain growth, and residual stresses. Thus, one or more thermal treatments may have been performed on the welded material (including pre- and/or post-heat treatments) to relieve some of those residual stresses and minimize cracking. In accordance with embodiments of the present disclosure, the friction stirring material may then subsequently be friction stir processed to achieve an improved fine-grained microstructure (with improved material properties).

A number of prior art FSW patents disclose various tooling and techniques to obtain welds that have beneficial characteristics over contemporary fusion welding processes. These benefits include low distortion in long welds, no fumes, little or no porosity, little or no splatter, and excellent mechanical properties regarding tensile strength. The process is especially useful for preventing significant heat damage or otherwise altering the properties of the original material being welded. For example, material being welded by FSW generally does not melt and cool rapidly enough during the FSW process to create heat affected zones (HAZ). Additionally, materials that were previously considered to be unweldable, or very difficult to weld, may be friction stir welded.

Furthermore, the solid-state processing principles associated with the friction stirring methods of the present disclosure may likely reduce the microstructure defects present in the original weld or deposit, reducing the incidence of cracking. By reducing the incidence of cracking, the need for additional heat processing treatments, such as pre- and/or post-heat treatments may be eliminated. Moreover, the processing technique may be less hazardous, which may also allow for the hardfacing to be treated at any given location, including at the rig site, allowing for better rebuild service. Lower asperity heights (i.e., reduced surface roughness) may also be achievable, giving a smoother finish, and reducing an apparent need for surface finishing or grinding.

In addition to the above mentioned benefits of friction stirring over conventional welding techniques, a greater hardness of the friction stirring material may be achieved without losing toughness. Specifically, conventional welding generally results in materials having an inverse relationship between strength and toughness (toughness decreases as strength is increased). However, friction stirring results in materials having a refined grain microstructure. Refined grain microstructures provide the friction stirred material with increased toughness and increased strength, as well as increased corrosion resistance, and other favorable material characteristics.

The hardness increase obtained by friction stirring depends on the hardness of the starting material's initial composition and on the heat treatment conditions applied. Conventional leg material, such as 4815 steel, may show a slight increase in hardness from friction stirring. On the other hand, friction stirring annealed 4130 steel, 4140 steel, and other air hardenable steels, such as D2 or M2, will show significant increase in hardness. For example, D2 hardness can be changed from 20 HRc to 55-65 HRc depending on the processing conditions.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A roller cone drill bit, comprising:
a bit body;
at least one leg extending downward from the bit body, wherein each leg comprises:
an outer surface that is surface processed by friction stirring;
a ball hole plug located in the outer surface;
a shoulder; and
a shirttail; and
a roller cone rotatably mounted on each leg.

2. The roller cone drill bit of claim 1, wherein the outer surface comprises a material selected from at least one of austenitic stainless steel, carbon steels, low alloy carburizing steel, high alloy carbon steel, and cobalt and nickel base alloys.

3. The roller cone drill bit of claim 2, wherein the high alloy materials are nickel based materials.

4. The roller cone drill bit of claim 2 wherein the high melting temperature material is selected from the group of ferrous alloys, non-ferrous materials, super alloys, titanium, cobalt alloys and air hardened or high speed steels.

5. The roller cone drill bit of claim 1, wherein the at least one leg is heat treated.

6. The roller cone drill bit of claim 1, further comprising a plate friction stir welded to the outer surface of at least one leg.

7. The roller cone drill bit of claim 6, wherein the ball hole plug is welded prior to friction stir welding the plate.

8. The roller cone drill bit of claim 1, wherein the outer surface is surface processed extending from a first distance from a leading side of the leg to a second distance from a trailing side of the leg and from a third distance from the shirttail to a fourth distance from the shoulder and wherein at least a portion of the surface processed outer surface comprises a wear resistant material.

9. The roller cone drill bit of claim 8, wherein the shirttail is hardfaced.

10. A method for surface processing a roller cone drill bit wherein the roller cone drill bit comprises a bit body and at least one leg extending from the bit body wherein each leg comprises an outer surface, comprising:
friction stirring the outer surface of a leg using a friction stir welding tool.

11. The method of claim 10, wherein the outer surface of the at least one leg comprises carburized steel.

12. The method of claim 10, wherein the outer surface of the at least one leg comprises from about 10 to about 20 weight percent of carbon.

13. The method of claim 10, wherein a portion of the outer surface of the at least one leg is surface processed by friction stirring.

14. The method of claim 10, wherein the majority of the outer surface of the at least one leg is surface processed by friction stirring.

15. A method for surface processing a roller cone drill bit wherein the roller cone drill bit comprises a bit body and at least one leg extending downward from the bit body, wherein each leg comprises an outer surface, comprising:
applying a wear resistant material to the roller cone drill bit; and
friction stir mixing the wear resistant material into the roller cone drill bit.

16. The method of claim 15, wherein the wear resistant material comprises hard particles selected from at least one of carbides, oxides and nitrides.

17. The method of claim 15, wherein the wear resistant material is tungsten carbide.

18. The method of claim 15, wherein a portion of the outer surface of the at least one leg is surface processed.

19. The method of claim 15, wherein the majority of the outer surface of the at least one leg is surface processed.

20. The method of claim 15, wherein the wear resistant material is applied by thermal spraying.

21. A method for manufacturing a roller cone drill bit wherein the roller cone drill bit comprises a bit body and at least one leg extending from the bit body wherein each leg comprises an outer surface, comprising:
assembling the roller cone drill bit;
attaching a plate to the outer surface of a leg; and
friction stir welding the plate to the outer surface of a leg.

22. The method of claim 21, wherein friction stir welding the plate to the outer surface of the at least one leg results in the leg having an increased yield strength, an increased hardness, an increased corrosion resistance, or a combination thereof.

23. The method of claim 21, wherein the plate is friction stir welded to the outer surface of the at least one leg prior to assembling the roller cone drill bit.

24. The method of claim 21, wherein the plate is friction stir welded to the outer surface of the at least one leg after assembling the roller cone drill bit.

25. The method of claim 21, wherein the plate is attached to a portion of the outer surface of the at least one leg by friction stir welding.

26. The method of claim 21, wherein the plate is attached to a majority of the outer surface of the at least one leg by friction stir welding.

27. The method of claim 21, wherein the roller cone drill bit further comprises a ball hole plug and a dimple in the outer surface of each leg.

28. The method of claim 27, wherein the plate is attached to the ball hole plug and the dimple.

29. The method of claim 21, further comprising performing at least one heat treatment on at least a portion of the roller cone drill bit.

30. The method of claim 29, wherein the at least one heat treatment is performed prior to friction stir welding the plate to the outer surface of the at least one leg.

31. The method of claim 29, wherein the at least one heat treatment is performed after friction stir welding the plate to the outer surface of the at least one leg.

32. The method of claim 21, wherein the plate comprises an air hardenable steel.

33. The method of claim 32, wherein the air hardenable steel is D2 tool steel.

34. The method of claim 21, wherein the plate comprises tungsten carbide particles dispersed therein.

35. A method for manufacturing a roller cone drill bit wherein the roller cone drill bit comprises a bit body and at least one leg extending from the bit body wherein each leg comprises an outer surface, comprising:
assembling the roller cone drill bit;
attaching a hardface tape;
attaching a plate; and
friction stir welding the plate and hardface tape to the outer surface of a leg.

36. The method of claim 35, wherein the hardface tape comprises tungsten carbide particles dispersed therein.

37. The method of claim 35, wherein the plate comprises an air hardenable steel.
